(19) United States
(12) Patent Application Publication
(10) Pub. No.: US 2005/0039139 A1
(43) Pub. Date: Feb. 17, 2005

(54) Linked two-paned user interface for selecting and administering objects within a computer system

(75) Inventors: Jon Schwartz, Bellevue, WA (US); Walt Morrison, Kent, WA (US)

Correspondence Address: Kory D. Christensen;STOEL RIVES LLP, One Utah Center, Suite 1100, 201 South Main Street, Salt Lake City, UT, 84111, US

(73) Assignee: Solance Technologies, Inc., Ashland, OR (US)

(21) Appl. No.: 10/917,119

(22) Filed: Aug. 12, 2004

Related U.S. Application Data
(60) Provisional application No. 60/494,391, filed on Aug. 12, 2003.

(51) Int. Cl. G09G 5/00

(52) U.S. Cl. 715/804; 715/805

(57) ABSTRACT

A user interface includes a selection window for allowing a user to select one of a plurality of displayed objects, each of which include at least one identifying attribute. The user interface also includes an administration window disposed adjacent to the section window for displaying a plurality of user-modifiable attributes of a selected object. The selection and administration windows are synchronized such that a user selection of an object in the selection window results in a presentation of one or more attributes of the selected object within the administration window. In the other direction, a user modification of an identifying attribute of an object within the administration window results in a corresponding change to the identifying attribute of the object within the selection window.

### CROSS-REFERENCE TO RELATED APPLICATIONS

This application claims the benefit of Provisional Application No. 60/494,391, filed Aug. 12, 2003, for “Linked Two-Pane User Interface for Administering and Managing Objects in a Computer System,” with inventors Jon Schwartz and Walt Morrison, which application is incorporated herein by reference in its entirety.

### TECHNICAL FIELD

The present invention relates generally to the field of data processing. More specifically, the present invention relates to user interfaces for data processing systems.

### COPYRIGHT NOTICE

®2004 Solance Technologies, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### BACKGROUND OF THE INVENTION

Objects represented in any software system are accessed and manipulated through a user interface (UI). A software system might include, for example, a number of objects representing “users” who have access to the system or “customers” whose orders are being processed within the system. The UI allows an operator to select and “administer” objects, e.g., edit selected properties of an object, move the object between folders or other storage locations, delete the object, etc.

Unfortunately, conventional UIs for selecting and administering objects are less than ideal. For instance, in Microsoft Explorer™, selection and administration of objects is completely disconnected and overly complicated. Furthermore, current UIs for selecting and administering objects are radically inconsistent, forcing a user to learn many different techniques for performing basically the same operations.

### BRIEF DESCRIPTION OF THE DRAWINGS

FIG. 1 is a first example of a conventional user interface for selecting and administering objects;

FIG. 2 is a second example of a conventional user interface for selecting and administering objects;

FIG. 3 is a third example of a conventional user interface for selecting and administering objects;

FIG. 4 is a user interface including a selection window;

FIG. 5 is a user interface for selecting and administering an “Owner” object;

FIG. 6 is a user interface for selecting and administering a “Workstation” object;

FIG. 7 is a block diagram illustrating synchronization of the selection and administration windows of two computers across a network;

FIG. 8 is a user interface for selecting and administering an “Asset” object;

FIG. 9 is a user interface for selecting an “Asset” object in the context of selecting and administering a “Workstation” object; and

FIG. 10 is a flowchart of a method for selecting and administering an object within a computer system.

### DETAILED DESCRIPTION

Reference is now made to the figures in which like reference numerals refer to like elements. For clarity, the first digit of a reference numeral indicates the figure number in which the corresponding element is first used.

In the following description, numerous specific details of programming, software windows, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

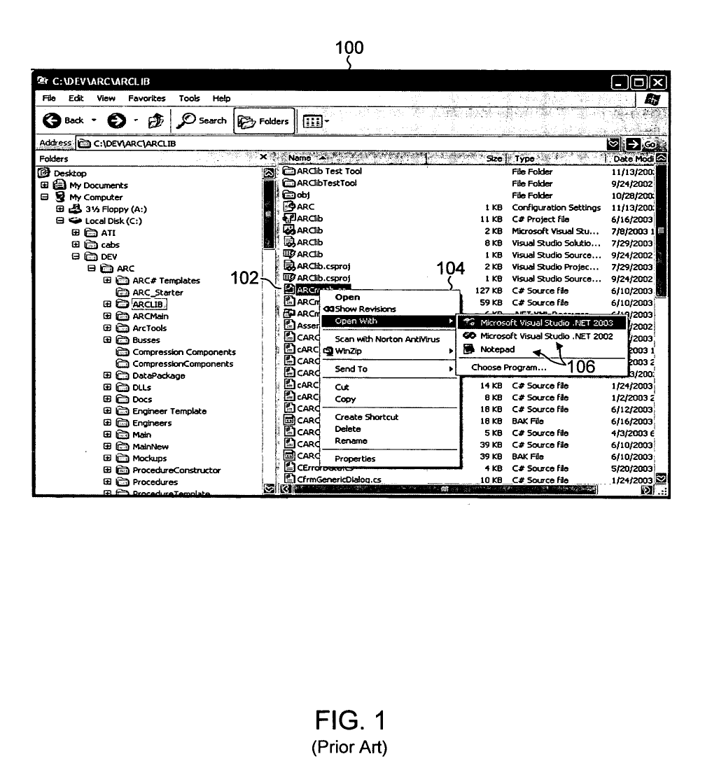

FIG. 1 illustrates a conventional interface for object selection and manipulation within a computer system. The Windows™ operating system provides an “explorer” 100, which is a UI for browsing and selecting contents of a computer hard disk. Suppose that a user wishes to edit an object 102 called “arcmath.cs,” a file containing C-sharp code. The user would need to select the object 102 by clicking on it with the right mouse button. Thereafter, the explorer 100 would display a context menu 104, allowing the user to select from various application programs 106 (e.g., Visual Studio .NET 2003, Visual Studio .NET 2002, notepad) to edit the selected object 102.

Unfortunately, any application programs 106 used to edit the selected object 102 are completely disconnected from the explorer 100 once they are launched. Furthermore, they are typically launched in separate, often radically inconsistent, windows, which generally overlap or completely obscure the explorer 100. Finally, they have no way to inform the explorer 100 when they have saved changes to the object.

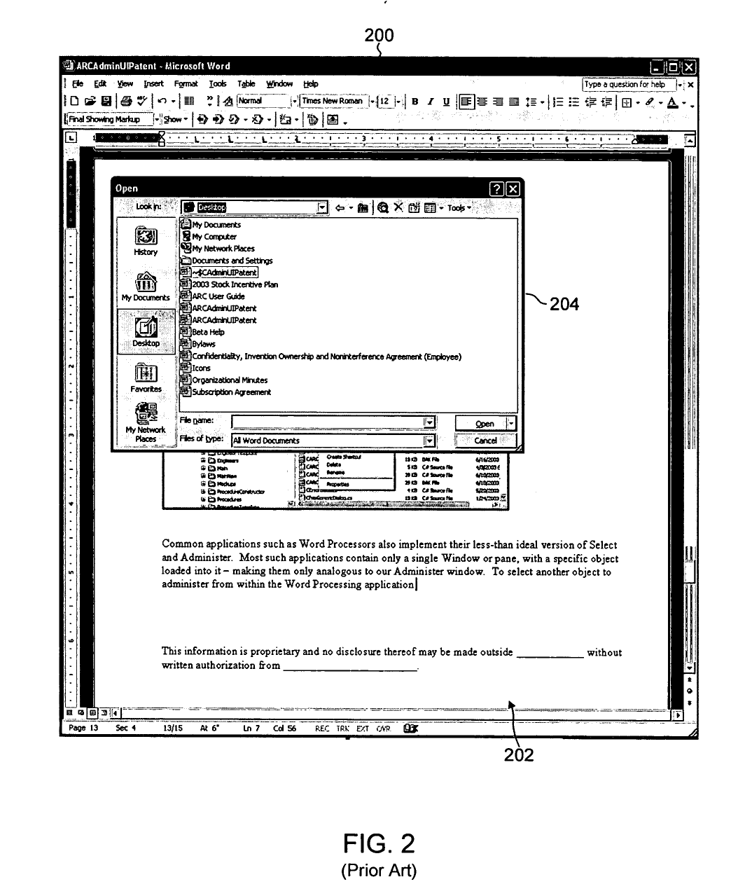

As shown in FIG. 2, common object-editing applications 200, such as word processors, also implement less-than-ideal UIs for selection and administration of objects 202. Most of such editing applications 200 contain only a single window or “pane,” with a specific object 202, such as a document, loaded into it. To select another object 102 to administer from within a word processing application 200, the user would typically select a “File Open” command, which displays an open dialog 204.

Microsoft and other application developers have long tried to implement an open dialog 204 that works well to help users find the object 202 they want to edit, but all such efforts have met with failure. Lack of consistency, lack of simplicity, and the forcing of a computer user to deal with the arcane organization of files on the hard disk—these problems are profound, and can be corrected by using the techniques described hereafter.

Beyond the problems with the selection UI in helping users to find the object they want to work with, the open dialog 204 is modal, i.e., it appears on top of the application 200, hiding the application 200 until the open dialog 204 is closed. Thus the “selection” UI cannot be left up alongside the “administration” UI. The communication between the open dialog 204 and the application 200 is fundamentally one-directional; no flexible interface exists to allow sophisticated communication and coordination between the “selection” and “administration” UIs.

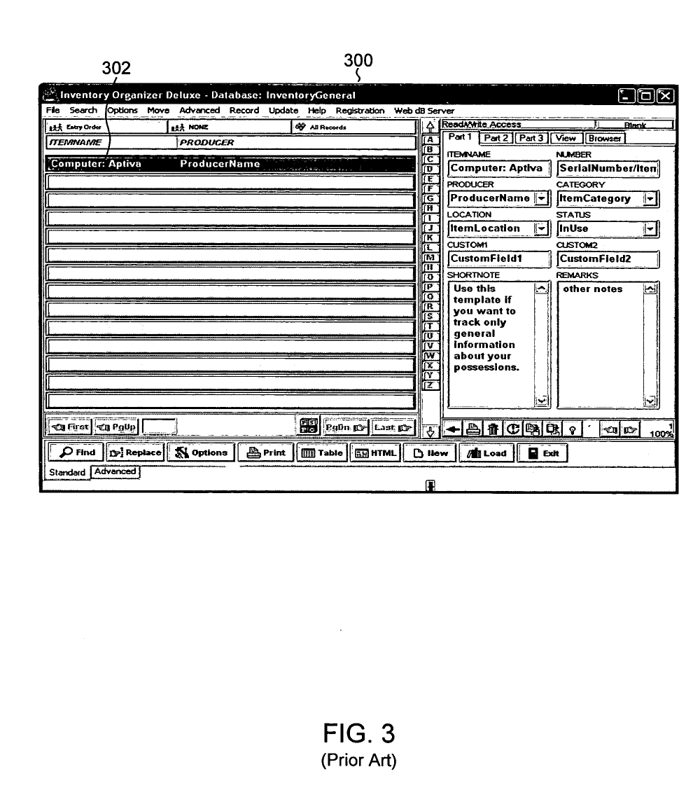

As shown in FIG. 3, certain object-management applications 300 are designed to facilitate the selection and administrations of objects in a data store. For example, an inventory management application 300 allows a user to select and administer various inventory items, such as “Computer” objects 302.

Unfortunately, standard object-management applications 300 are likewise deficient in a number of respects. The illustrated UI is a fixed, single-pane design. As such, there is no way to complete tasks solely from the “selection” window, i.e., without the need for a separate and more complex “administration” window to be displayed. In this design, the two are permanently displayed.

Moreover, the fixed nature of the design makes it difficult to administer different types of objects differently. No matter the object or its real-world properties, it can be administered only in the right-side pane. Object-oriented reuse for different types of applications or objects would be likewise difficult or impossible. Finally, there is no direct search capability built into the visible UI. More generally, as is usually the case, the UI is extremely cluttered and complex, far more so than is optimum for an ideal user experience.

As described more fully below, the above-identified problems and disadvantages may be solved by a linked, two-paned interface for selecting and administering objects. One novel aspect involves a UI design that logically and visibly separates the selection and administration workflow from the user's point of view. Because these tasks are logically separate, using separate windows is more intuitive for the user, and the distinct commands associated with each step are separately and logically available in each window. For instance, on a selection window, the UI may allow the user to view a list of objects, create a new instance of an object, administer an existing object, or delete an object. The administration window displays all the properties of the selected object, allows that object to be changed, and allows changes made by the user to be either saved or cancelled.

Another aspect involves synchronizing the selection and administration windows such that information changed in one window is automatically updated in the other window. For instance, selecting an object within a selection window may result in a presentation of one or more user-modifiable attributes within an administration window. Thereafter, modifying an attribute within the administration window may cause the same attribute, if also displayed within the selection window, to be correspondingly changed. As will be described in detail, this synchronization may be achieved using an XML-based interface that provides for sophisticated communication and coordination between the “selection” and “administration” UIs.

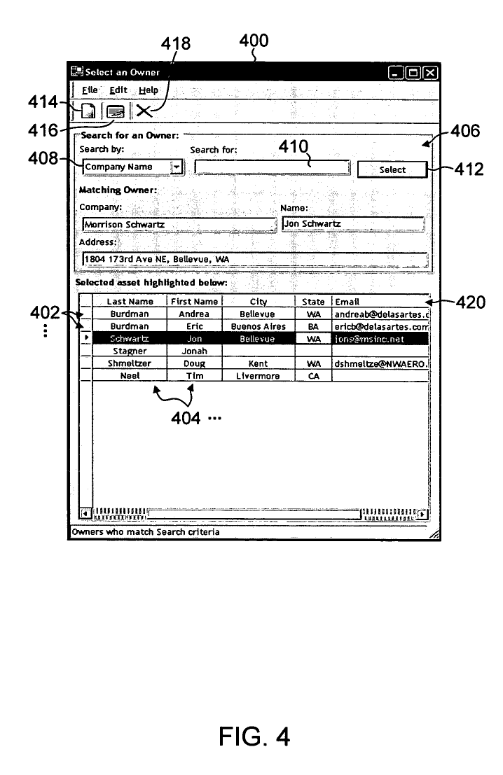

Referring to FIG. 4, there is shown a selection window 400 according to an embodiment of the invention. The selection window 400 may display a plurality of objects 402, such as “Owners” in the depicted embodiment. The objects may be displayed as icons or other graphical representations. Alternatively, as shown in FIG. 4, the objects 402 may be displayed as text in the form of a list of attributes 404 of each object 402. Examples of attributes 404 may include “Last Name,” “First Name,” “City,” “State,” etc. The attributes in the selection window 400 may be termed “identifying” attributes 404 since they serve to identify their respective objects 402. In still other embodiments, the objects 402 may be represented in the selection window 400 using a combination of text and graphics.

In one implementation, only the selection window 400 is initially displayed, since, depending on the task, the user might be able to complete the task entirely within the selection window 400. This reduces screen clutter and emphasizes the separate “selection” and “administration” metaphor. As an example, the user simply may be looking up the email address of a specific customer, which may not require administration or modification of an object or its properties, as discussed in greater detail below.

In the illustrated embodiment, several features make certain tasks easy to complete solely within the selection window 400. For example, the selection window 400 may present multiple columns of information representing attributes 404 of each object 402. While the depicted objects 402 and attributes 404 are embodied within rows and columns in a spreadsheet-like format, those of skill in the art will recognize that other representations may be used. Additionally, the selection window 400 is fully resizable in one embodiment, and a list of objects 402 within the selection window 400 may be scrollable, allowing more objects 402 to be displayed than can be physically accommodated by the window 400.

Since the list of objects 402 may be large, the selection window 400 may include a search mechanism 406 for allowing the user to filter the displayed objects 402 to include only those objects 402 having particular user-specified attributes 404. The search mechanism may be implemented using a drop-down menu 408 to select a type of attribute 404, and a text entry box 410 to allow the user to input the specific attribute 404 to search for. A “Select” button 412 or the like may be provided to allow a user to initiate a search.

In certain embodiments, the selection window 400 may also provide buttons or other controls 414, 416, 418 to access various universal functions for managing all objects 402 regardless of type. Consequently, such controls 414, 416, 418 may be included in every selection window 400 to provide the user with consistency across applications or across components of a large application or framework.

For example, the selection window 400 may include a control 414 for accessing a universal function to create a new instance of an object 402. Likewise, the selection window 400 may include a control 416 for accessing a universal function to administer or modify one or more attributes 404 of an object 402. Finally, the selection window 400 may include a control 418 for accessing a universal function to delete an object 402. Other controls may be provided, including various universal (ie., applies to all object types) and non-universal (i.e., applies to specific object types) controls. However, in one embodiment, to achieve consistency for the user, the provided universal controls 414, 416, 418 are limited to those described above.

As illustrated, the selection window 400 may also include a sorting mechanism 420 to sort the objects 402 by one or more user-specified attributes 404. For instance, the user may sort the list of objects 402 by the “Last Name” attribute 404, the “City” attribute 404, the “State” attribute 404, or the like, by clicking on the corresponding attribute's name.

The sorting mechanism 420 may be used in one embodiment to enable the user to execute simple searches. For instance, where the user knows that a desired object 402 has a “State” attribute 404 of “CA,” the user could click on the “State” attribute 402 within the sorting mechanism 420 to reorder the list according to state. The user could then scroll to the point in the list where the “State” attribute 404 is “CA” to visually locate the desired object 402.

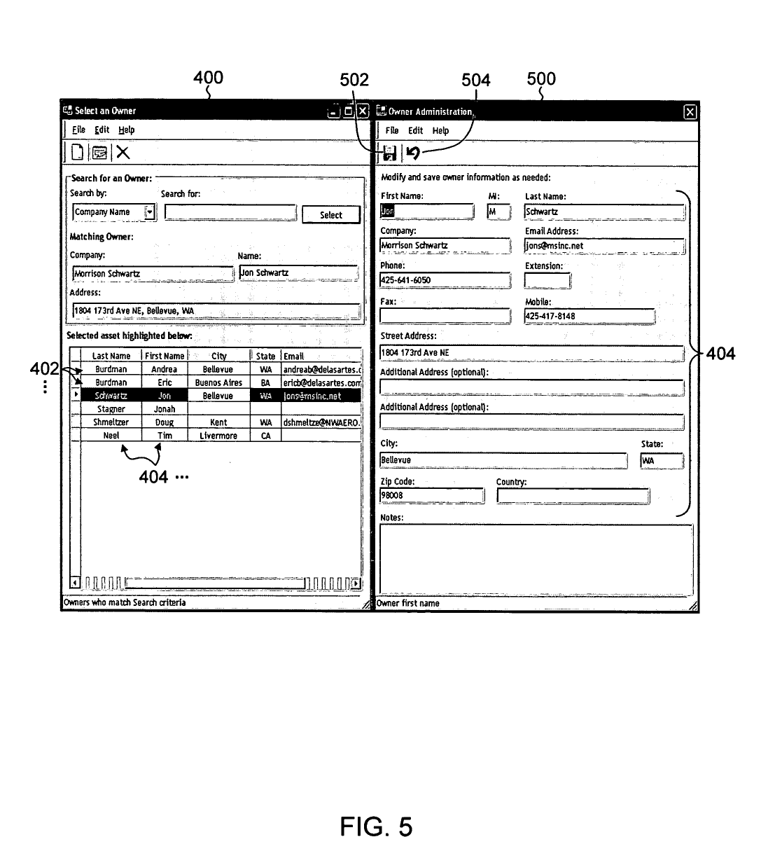

Referring to FIG. 5, once the user has selected an object 402, for example, by clicking on it with a mouse, the user may choose to administer the object 402. This may be accomplished in various ways, e.g., activating the “administration” control 416, selecting a menu option, or double-clicking on the object 402. Thereafter, the system displays an administration window 500 adjacent to the selection window 400.

As illustrated, the administration window 500 may be substantially the same height as the selection window 400 and may be vertically aligned with it. Nevertheless, the selection window 400 and the administration window 500 comprise two separate windows in one embodiment. For example, in the Windows API, each window would have its own handle.

The administration window 500 displays the attributes 404 (or a subset thereof) of the selected object 402. The administration window 500 also allows the user to modify one or more of the attributes 404. For example, in the illustrated embodiment, the attributes 404 are displayed in editable text fields.

Like the selection window 400, the administration window 500 may include a number of controls 502, 504 for accessing universal functions that apply to all objects regardless of type. As illustrated, a control 502 may be provided to access a universal function for saving any changes made to the object's attributes 404. Also included may be a control 504 to access a universal function for discarding any changes that have been made to the attributes 404, causing the administration window 500 to revert to the object's original attributes 404 before any changes were made. In various implementations, the user is automatically prompted whether to save the changes if the user attempts to close the administration window 500, select another object 402 from the selection window 400, or the like.

As in the case of the selection window 400, the administration window 500 may include additional controls to access both universal and non-universal functions. However, to ensure consistency from the user's perspective, the only universal functions, in one embodiment, may be the ones listed above.

Those of skill in the art will recognize that consistency is an important factor in determining a user's level of comfort and efficiency when working within a software system. Objects 402 of different types—and multiple types of objects 402—are normally part of any complex software system. Objects 402 are different because they have differing attributes 404 or properties. On the other hand, the process and the user experience of selecting and administering objects 402 should be as consistent as possible, exposing the user only to the changes dictated by the objects' differing properties.

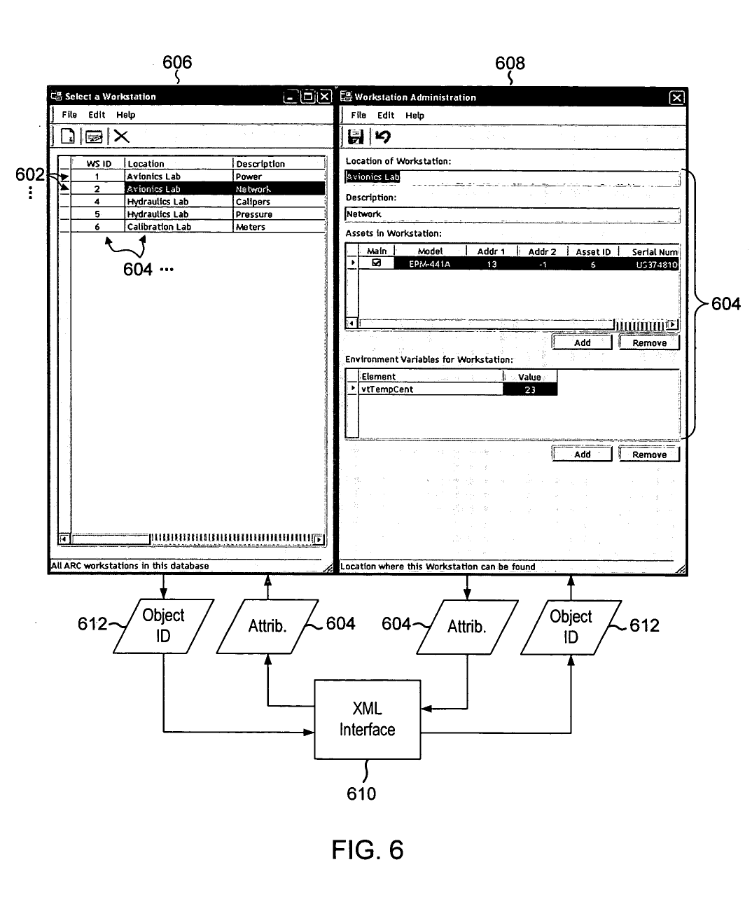

FIG. 6 illustrates an example of selecting and administering a “Workstation” object 602. This screen shot was generated by the same software system that implements the “Owner” administration of FIG. 5. The consistency of user interface and user experience ensures that the user only needs to learn one technique for selecting and administering objects 402, 602, unlike the conventional approaches discussed previously.

Note that this consistency is achieved without being rigid. In FIG. 5, the attributes 404 presented for selecting an object 402 to administer are a unique combination of user name and full name. Nothing further is required to select a specific user within the system. For “Workstation” objects 602, on the other hand, three different attributes 604 might be useful for selecting a specific workstation (e.g., ID, Location and Description), which are displayed within a “Workstation” selection window 606. Theetails of administering an “Owner” objection and a “Workstation” selection window 606. The different because the attributes 404, 604 which define them are different. Nevertheless, the window context, the workflow, and the user interface commands are exactly consistent.

In one embodiment, an XML-based interface 610 allows the “Workstation” selection window 606 to exchange information with a “Workstation” administration window 608. For instance, the selection window 606 passes an ID 612 of the object 602 to be administered to the administration window 608, after which the administration window 608 loads and displays the attributes 604 for that object 602.

In the other direction, when the administration window 608 has saved changes to one or more identifying attributes 604 of an object 602 that are also shown in the selection window 606, the administration window 608 sends the changed attribute(s) 604 to the selection window 606, which will reload to display the changed attribute(s) 604. Thus, the selection and administration windows 606, 608 remain synchronized.

An example of XML code used for notifying the administration window 608 of the selection of an object 602 is as follows:

<

UI
FormName=“FrmWorkstationAdmin”
FormSQLString=“ ”
FormLanguage=“0”
ParentGUID=“79728556-83c1-4e5e-9fd8-9f3c09c29252”
txtCaption=“ ”
txtText=“ ”
Buttons=“0”
DefaultButton=“0”
Icon=“0”
LinesOfInput=“0”
ParamValue=“&amp;lt;WorkstationAdmin

bNew=&quot;False&quot; nUID=&quot;10&quot; /&amp;gt;”

DLLNameSpace=“ ”
ParentTop=“0”
ParentLeft=“0”
ParentWidth=“400”
ParentHeight=“738”

/>

In this example, the “UI” node type specifies that this XML code defines a UI component to be launched. “FormName” is the name of the UI window to launch, as defined in the executable code that implements the UI. “FormSQLString” is an optional SQL string that can be used to provide the form with data. “FormLanguage” is the language used to display the form (0=English (US), 1=Spanish, etc.). “ParentGUID” is a unique identifier for the parent form that is sending this request (used for routing back uniquely to the parent form).

In one embodiment, “txtCaption” is an optional field for specifying a caption for the new UI displayed, while “txtText” is an optional field for specifying the text label displayed on the new UI. “Buttons” is an optional field to specify the kinds of buttons displayed if it is a dialog (I.e. OK/Cancel, Yes/No, etc.). “DefaultButton” is an optional field specifying the default button, if a dialog, “Icon” is an optional field specifying an icon to use for the displayed UI. “LinesOfinput” is an optional field specifying how many lines of input to allow, for multiline text input. “ParentTop” is the pixel coordinate of the top of the parent UI (for alignment of the new UI). “ParentLeft” is the pixel coordinate of the left of the parent UI (for alignment of the new UI). “ParentWidth” is the pixel width of the parent UI (for alignment of the new UI). “ParentHeight” is the pixel height of parent UI (for alignment of the new UI). “ParamValue” is an optional field allowing any custom values to be sent to the new UI, as XML. Finally, “DLLNameSpace” is an optional field allowing the UI component to be launched from a different DLL namespace than the one in which the parent UI is implemented

An example of XML code used for notifying the selection window 606 concerning a change to an attribute 604 within the administration window 608 is as follows:

<

F2VO_SEND
NodeType=“objectchanged”
UID=“10”
ObjectType=“owner”
ChangingFormGUID=“5293acb8-6e5d-496b-a9ba-

26cd5370393c”

FormGUID=“5293acb8-6e5d-496b-a9ba-26cd5370393c”
ParentGUID=“79728556-83c1-4e5e-9fd8-9f3c09c29252”

/>

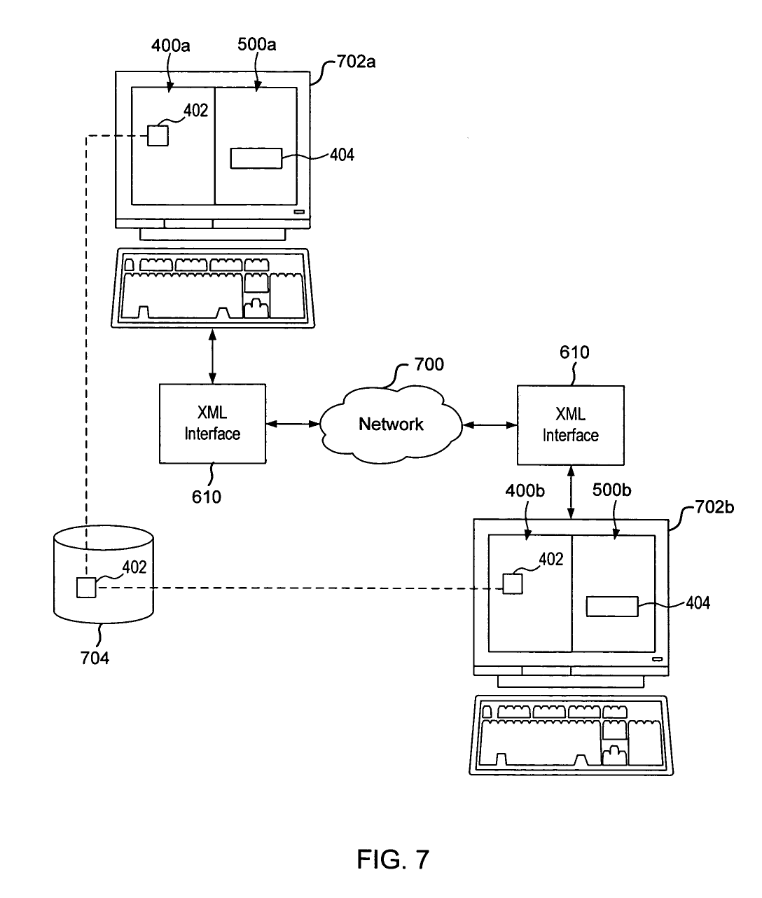

In this second example, “F2VO_SEND” identifies a message that is routed from a UI form to a “virtual operator”, which, in turn, routes messages as required through the system. The virtual operator broadcasts this change throughout the system, and any other components or UIs in the system which would be effected by this message can behave as required. For instance, someone else who is looking at the same owner object 402 that has been changed will immediately be notified of this change, as will be discussed in greater detail with respect to FIG. 7.

In one embodiment, “NodeType” identifies the type of node being sent, with “objectchanged” being the relevant type to this discussion. “UID” is a unique identifier of the object which has been changed (so other parts of the distributed system can know whether this change is relevant to them). “ObjectType” is a type of the object which has been changed (so other parts of the distributed system can know whether this change is relevant to them). “ChangingFormGUID” is a unique identifier of the UI window on which the reported change occurred. “FormGUID” is a unique identifier of the window that is reporting this change to the rest of the system (these two values are typically but not necessarily the same). “ParentGUID” is a unique identifier of the parent window of the window which is reporting this change to the rest of the system.

Because this is an XML-based interface, it is completely extensible. If specific objects require additional information be exchanged between the forms, this additional information can simply be added to the XML interface. Despite the benefits of XML, those of skill in the art will recognize that other types of interfaces may be used. For example, other variants of SGML, such as HTML, may be used to synchronize the selection and administration windows 606, 608. In still other embodiments, an interface that is not based on a markup language may be used.

In one embodiment, as shown in FIG. 7, the same instance of an object 402 (such as the “Owner” object of FIGS. 4-5) may be administered over a network 700 by two or more computers 702a-b. The object 402 may be stored within a commonly-accessible database 704 or the like. An XML-based (or other) interface 610 may be used to synchronize a set of selection and administration windows 400a, 500a on each computer 702a-b such that any modification of an attribute 404 on one computer 702a-b will result in a corresponding change to the attribute 404 on the other computer 702a-b. Such synchronization may automatically occur, for example, when the user saves the changes by activating the “Save” control 502 of FIG. 5.

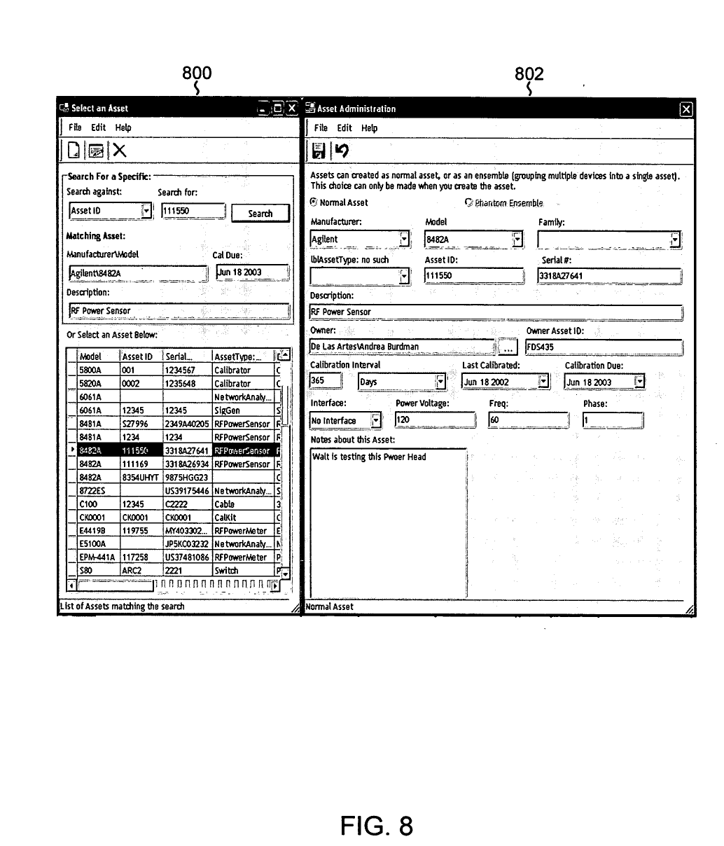

Referring to FIG. 8, object-oriented design allows UI components to be reused in one embodiment. For example, FIG. 8 illustrates a select/administer UI for electronic assets. Like the other UIs discussed above, the illustrated UI includes an asset selection window 800 and an asset administration window 802.

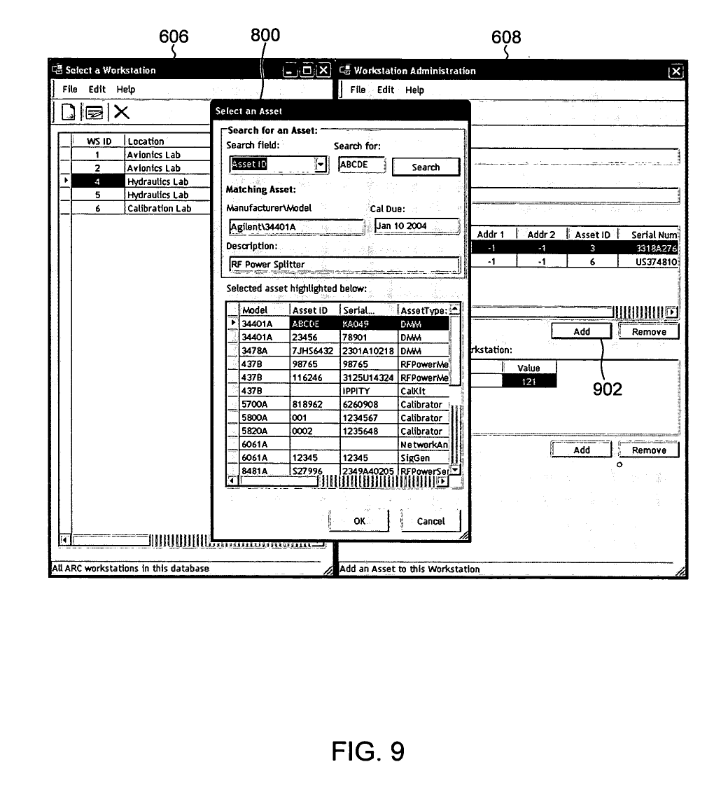

An example of reuse is shown in FIG. 9. Note that the UI of FIG. 9 is the same interface for selecting and administering a workstation as depicted in FIG. 6. However, in the administration window 608 for the workstation, the user has clicked an “Add” button 902 which allows the user to add an asset to the list of assets associated with the workstation. An “Asset” selection window 800 identical to the one in FIG. 8 then displayed, allowing the user to select the asset to add to the workstation. The same “Asset” selection window 800 is used because, in one embodiment, the controls implementing the asset select window 800 have been packaged as a reusable object-oriented component.

Among the many advantages of applying object-oriented reuse to the above-described techniques include: 1) quicker implementation time, 2) inherent user consistency, 3) improved system reliability (if it works in one place, it will work in the other), and 4) simplified maintenance of the system code, since the code is only implemented in a single object. Any time the selection UI will be used in multiple parts of the system, it can be packaged this way and receive these advantages.

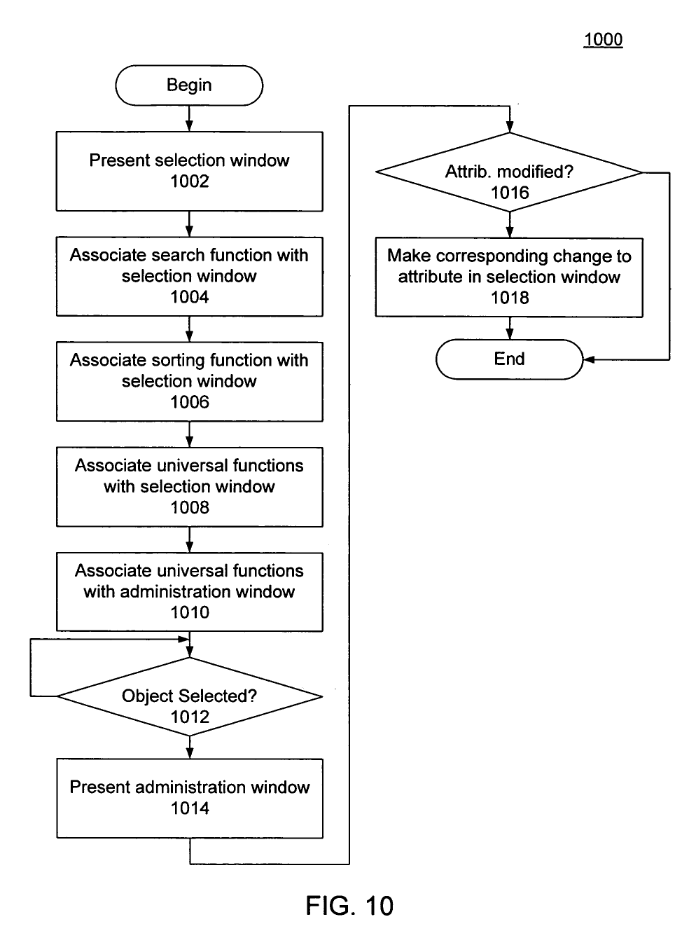

FIG. 10 is a flowchart of a method 1000 for selecting and administering objects within a computer system. Initially, the system presents 1002 a selection window for allowing a user to select one of a plurality of displayed objects. As previously discussed, each object includes at least one identifying attribute, such as a name or other type of identifier.

In one embodiment, the system associates 1004 a search function with the selection window for enabling the user to filter the displayed objects to include only those objects having one or more user-specified attributes. In addition, or in the alternative, the system may associate 1006 a sorting function with the selection window to sort the displayed objects by a user-specified attribute.

The system may also associate 1008 a set of universal functions with the selection window that apply to all objects regardless of type. The set of universal functions may include, for example, a “creation” function for allowing a user to create a new object, an “administration” function for allowing a user to selectively modify one or more attributes of an existing object, and a “deletion” function for allowing a user to delete an object.

Likewise, the system may associate 1010 a set of universal functions with the administration window that apply to all objects regardless of type. In various embodiments, the set of universal functions may include a “save” function for saving changes made to one or more attributes of an object and a “discard” function for discarding changes made to one or more attributes of an object.

The system waits at step 1012, in one implementation, until the user selects an object from the selection window. Once an object is selected, the system presents 1014 an administration window adjacent to the selection window. In various embodiments, the administration window is substantially the same height as, and vertically-aligned with, the selection window.

The system then determines at step 1016 whether the user has modified one of the identifying attributes of the object within the administration window. If an attribute has been changed, the system automatically makes 1018 a corresponding change to the attribute within the selection window, thus synchronizing the selection and administration windows.

In summary, the above-described techniques provide a number of advantages not found in conventional approaches. In particular, the user experience is improved through greater consistency, without sacrificing the flexibility required for administering different types of objects with different properties and characteristics. An XML-based interface allows the two parts of the UI to communicate and coordinate. The two-paned interface described herein facilitates selection and administration of nearly all types of objects, but also allows for customization of the information exchanged, if required. Finally, an object-oriented design allows components of the interface to be easily reused within the same system or in other systems.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

Embodiments of the invention may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present invention may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for administrating objects within a computer system, comprising:
presenting a selection window for allowing a user to select one of a plurality of displayed objects, each object including at least one identifying attribute;
presenting an administration window adjacent to the selection window in response to a user selection of one of the displayed objects, the administration window including a one or more user-modifiable attributes of the selected object, wherein modification of an identifying attribute of the object within the administration window automatically results in a corresponding change to the identifying attribute within the selection window.

2. The method of claim 1, wherein the presenting an administration window comprises sizing the administration window to be substantially the same height as the selection window.

3. The method of claim 1, wherein presenting an administration window comprises placing the administration window so as to not overlap the selection window.

4. The method of claim 1, wherein presenting an administration window comprises vertically-aligning the administration window with the selection window.

5. The method of claim 1, further comprising:
associating a search function with the selection window for enabling the user to filter the displayed objects to include only those objects having one or more user-specified attributes.

6. The method of claim 1, further comprising:
associating a sorting function with the selection window to sort the displayed objects by a user-specified attribute.

7. The method of claim 1, further comprising:
associating a set of universal functions with the selection window that apply to all objects regardless of type, the set of universal functions including a creation function for allowing a user to create a new object, an administration function for allowing a user to selectively modify one or more attributes of an existing object, and a deletion function for allowing a user to delete an object.

8. The method of claim 1, further comprising:
associating a set of universal functions with the administration window that apply to all objects regardless of type, the set of universal functions comprising a save function for saving changes made to one or more attributes of an object and a discard function for discarding changes made to one or more attributes of an object.

9. The method of claim 1, further comprising:
synchronizing the selection and administration windows using an XML-based interface such that a user selection of an object in the selection window causes an identifier of the selected object to be passed to the administration window resulting in a presentation of one or more user-modifiable attributes of the selected object within the administration window, and wherein a user modification of an identifying attribute within the administration window causes an indication of the identifying attribute to be passed to the selection window resulting in a corresponding change to the identifying attribute within the selection window.

10. The method of claim 1, further comprising:
synchronizing the selection and administration windows with another set of selection and administration windows being displayed on a different computer system that is administering the same object, wherein modification of an attribute of the object within one set of selection and administration windows results in a corresponding change to the attribute within the other set of selection and administration windows.

11. A method for administering objects within a computer system, comprising:
presenting two non-overlapping windows including a selection window for allowing a user to select one of a plurality of displayed objects and an administration window for allowing the user to modify one or more attributes of the selected object;
displaying one or more identifying attributes for each object within the selection window;
synchronizing the selection and administration windows using an XML-based interface such that a user selection of an object in the selection window results in a presentation of one or more attributes of the selected object within the administration window, and wherein a user modification of an identifying attribute of an object within the administration window results in a corresponding change to the identifying attribute of the object within the selection window.

12. The method of claim 11, wherein presenting comprises sizing the two non-overlapping windows to be substantially the same height.

13. The method of claim 11, wherein presenting comprises arranging the two non-overlapping windows to be adjacent to one another.

14. The method of claim 11, wherein presenting comprises vertically aligning the two non-overlapping windows.

15. The method of claim 11, further comprising:
associating a search function with the selection window for enabling the user to filter the displayed objects to include only those objects having one or more user-specified attributes.

16. The method of claim 11, further comprising:
associating a sorting function with the selection window to sort the displayed objects by a user-specified attribute.

17. The method of claim 11, further comprising:
associating a set of universal functions with the selection window that apply to all objects regardless of type, the set of universal functions including a creation function for allowing a user to create a new object, an administration function for allowing a user to modify one or more attributes of an existing object, and a deletion function for allowing a user to delete an object.

18. The method of claim 11, further comprising:
associating a set of universal functions with the administration window that apply to all objects regardless of type, the set of universal functions comprising a save function for saving changes made to one or more attributes of an object and a discard function for discarding changes made to one or more attributes of an object.

19. The method of claim 11, further comprising:
synchronizing the selection and administration windows with another set of selection and administration windows being displayed on a different computer system that is administering the same object, wherein modification of an attribute of the object within one set of selection and administration windows results in a corresponding change to the attribute within the other set of selection and administration windows.

20. The method of claim 11, wherein presenting comprises:
arranging the selection and administration windows side-by-side with the selection window being placed to the left of the administration window.

21. A method for administering objects within a computer system, comprising:
presenting a selection window for allowing a user to select one of a plurality of displayed objects, the selection window including a search function for enabling the user to filter the displayed objects to include only those objects having one or more user-specified attributes;
presenting a separate administration window substantially adjacent to the selection window for allowing the user to modify one or more attributes of the selected object;
associating a first set of universal functions with the selection window that apply to all objects regardless of type, the first set of universal functions including a creation function for creating a new object, an administration function for modifying one or more attributes of an existing object, and a deletion function for deleting an object.

22. The method of claim 21, further comprising:
associating a second set of universal functions with the administration window that apply to all objects regardless of type, the second set of universal functions comprising a save function for saving changes made to one or more attributes of an object and a discard function for discarding changes made to one or more attributes of an object.

23. The method of claim 21, wherein the presenting an administration window comprises sizing the administration window to be substantially the same height as the selection window.

24. The method of claim 21, wherein presenting an administration window comprises placing the administration window so as to not overlap the selection window.

25. The method of claim 21, wherein presenting an administration window comprises vertically-aligning the administration window with the selection window.

26. The method of claim 21, wherein presenting an administration window comprises placing the administration window to the right of the selection window.

27. The method of claim 21, further comprising:
synchronizing the selection and administration windows such that a user selection of an object in the selection window results in a presentation of one or more attributes of the selected object within the administration window, and wherein a user modification of an identifying attribute of an object within the administration window results in a corresponding change to the identifying attribute of the object within the selection window.

28. The method of claim 21, further comprising:
synchronizing the selection and administration windows with another set of selection and administration windows being displayed on a different computer system that is administering the same object, wherein modification of an attribute of the object within one set of selection and administration windows results in a corresponding change to the attribute within the other set of selection and administration windows.

29. The method of claim 21, further comprising:
associating a sorting function with the selection window to sort the displayed objects by a user-specified attribute.

30. A method for synchronizing objects across a network comprising:
presenting on a first computer system two non-overlapping windows including a selection window for allowing a user to select one of a plurality of displayed objects and an administration window for allowing the user to modify one or more attributes of the selected object, the selection and administration windows indicating one or more identifying attributes of the selected object; and
synchronizing the selection and administration windows on the first computer system with selection and administration windows on a second computer system displaying one or more attributes of the same selected object, wherein modification of an identifying attribute of the object within the selection or administration windows within the first computer system results in a corresponding change to the identifying attribute of the same object within the selection and administration windows of the second computer system.

31. A user interface for a computer system, comprising:
a selection window for allowing a user to select one of a plurality of displayed objects, each object including at least one identifying attribute; and
an administration window disposed adjacent to the section window for displaying a plurality of user-modifiable attributes of a selected object, wherein the selection and administration windows are synchronized such that a user selection of an object in the selection window results in a presentation of one or more attributes of the selected object within the administration window, and wherein a user modification of an identifying attribute of an object within the administration window results in a corresponding change to the identifying attribute of the object within the selection window.

32. The user interface of claim 31, wherein the selection and administration windows are non-overlapping, vertically aligned, and of substantially the same height.

33. The user interface of claim 31, further comprising:
a search mechanism within the selection window for enabling the user to filter the displayed objects to include only those objects having one or more user-specified attributes.

34. The user interface of claim 31, further comprising:
a sorting mechanism within the selection window to sort the displayed objects by a user-specified attribute.

35. The user interface of claim 31, further comprising:
a set of controls corresponding to universal functions within the selection window that apply to all objects regardless of type, the universal functions including a creation function for allowing a user to create a new object, an administration function for allowing a user to modify one or more attributes of an existing object, and a deletion function for allowing a user to delete an object.

36. The user interface of claim 32, further comprising:
a set of controls corresponding to universal functions with the administration window that apply to all objects regardless of type, the set of universal functions comprising a save function for saving changes made to one or more attributes of an object and a discard function for discarding changes made to one or more attributes of an object.

37. A user interface for a computer system, comprising:
a selection window for allowing a user to select one of a plurality of displayed objects, each object including at least one identifying attribute;
a separate administration window for displaying a plurality of user-modifiable attributes of a selected object, wherein the selection window and administration window are non-overlapping, vertically aligned, of substantially the same height, and disposed adjacent to one another, with the administration window being placed to the right of the selection window;
a search mechanism within the selection window for enabling the user to filter the displayed objects to include only those objects having one or more user-specified attributes;
a sorting mechanism within the selection window to sort the displayed objects by a user-specified attribute;
a set of controls corresponding to universal functions within the selection window that apply to all objects regardless of type, the universal functions including a creation function for allowing a user to create a new object, an administration function for allowing a user to modify one or more attributes of an existing object, and a deletion function for allowing a user to delete an object; and
a set of controls corresponding to universal functions with the administration window that apply to all objects regardless of type, the set of universal functions comprising a save function for saving changes made to one or more attributes of an object and a discard function for discarding changes made to one or more attributes of an object.

38. The user interface of claim 37, wherein the selection window and administration window are synchronized such that a user selection of an object in the selection window results in a presentation of one or more attributes of the selected object within the administration window, and wherein a user modification of an identifying attribute of an object within the administration window results in a corresponding change to the identifying attribute of the object within the selection window.

39. A computer program product comprising:
a computer-readable medium and computer-readable code embodied on said computer-readable medium for administrating objects within a computer system, the computer-readable code comprising:
computer-readable program code devices for presenting a selection window for allowing a user to select one of a plurality of displayed objects, each object including at least one identifying attribute; and
computer-readable program code devices for presenting an administration window adjacent to the section window in response to a user selection of one of the objects, the administration window displaying a plurality of user-modifiable attributes of the selected object, wherein modification of an identifying attribute of the selected object within the administration window results in a corresponding change to the identifying attribute of the selected object within the selection window.
